(19) United States
(12) Patent Application Publication
(10) Pub. No.: US 2013/0326949 A1
(43) Pub. Date: Dec. 12, 2013

(54) Expandable Planting Pot

(71) Applicant: Kevin Christopher Hale, Mount Morris, MI (US)

(72) Inventor: Kevin Christopher Hale, Mount Morris, MI (US)

(21) Appl. No.: 13/494,186

(22) Filed: Jun. 12, 2012

(51) Int. Cl. A01G 9/02

(52) U.S. Cl. 47/79

(57) ABSTRACT

The present invention discloses an expandable planting pot module mounted with a detachable bottom plate. The bottom plate may be configure to be a grinding tool to lose the bottom soil by twisting. The bottom plate is secured to the planting pot with a locking mechanism.

### DESCRIPTION OF RELATED ART

The present application relates to a planting pot or container, and more particularly to an expandable planting pot or container expandable or connectable to increase the overall capacity, designed to fight against transplant shock and to stimulate the growth of root system.

Note that the points discussed below may reflect the hindsight gained from the disclosed inventions, and are not necessarily admitted to be prior art.

When people grow crops or plants inside the nursery, they will transplant the crops to get the root system bigger so that the young crops could grow bigger and produce more.

Commonly, people will have to buy pots in different sizes to accommodate the transplanted crops or plants when the sizes of their roots increase. Often the root system could be damaged or the “transplant shock” could interrupt their growth and set them back by weeks. Therefore, a planting pot being connected to each other to gain bigger size is desired.

For example, the U.S. Pat. No. 5,930,951A describes a sectional planting pot which can be having a modular, threaded container stacking on one another to increase its size.

However, the modular container described in above patent cannot be used independently as regular planting pot, an expandable planting pot module where the bottom plate move to another position to expand in order to adopt to the growth of a root is still desired, such as the one provided by the present invention.

### SUMMARY

The present invention discloses an expandable planting pot module. Each module may be used as an independent planting pot with detachable bottom. The bottom plate mat be placed to another position to expand the pot holding capacity. Two or more such modules may be stacked to each other to create a bigger planting pot. It is downwardly extendable in growing space. Furthermore, the detachable pot bottom may have multiple teeth projecting upwardly into the bottom of the root ball, so as to generate grinding effect on the hardened root ball when being twisted off the pot module. The root grinding detachable bottom loosens up the bottom of the root ball to kick start the root system when being removed from the pot module. With proper stimulation made by the root grinding detachable bottom, the root system could be teased up and keep growing into expanded pot module.

In one embodiment, a connectable and expandable planting pot module includes a housing portion formed by lateral wall with interior and exterior surface, and a bottom portion which is detachably connected to lower end of housing portion, forming a housing space to accommodate growing medium. A plurality of apertures are configured along the edge of the bottom of pot module allowing water drainage and aeration. The housing portion has the same diameter in its lower end than its upper end, forming a recess at lower end of the lateral wall, thereby enabling lower end of housing portion to be securely slide into the upper end of housing portion of added planting pot module along the vertical axis of both housing portions.

In one aspect of an embodiment, the detachable bottom portion is securely screwed onto lower end of said housing portion.

In another aspect of an embodiment, the detachable bottom portion includes a plate, a belt with apertures on each end, and a handle to accommodate human hand, all of which are connected together to form a fastening mechanism. The belt can be bended into the interior wall of the pot to lock the bottom plate into position. Apertures are to engage with the protruding parts which are configured symmetrically on opposite sides of the housing portion. The plate is of substantially the same diameter as lower end of housing portion. Handle is placed against both belt and plate in described order. The handle, belt and plate are disposed together coaxially to perform the fastening function.

When twisting the handle, it will lock into the lower end of housing portion and tighten against the belt and plate until the whole bottom portion securely attached to the housing portion.

Yet in another aspect of an embodiment, the detachable bottom of the pot, when removed, may be used as a root grinder to kick starts the root system.

The present invention discloses a connectable planting pot module, suitable to be used individually and collectively. It can easily stacked together to provide extra growing space, designed to fight against transplant shock and to stimulate the growth of root system. It is convenient to use in both nurseries and families.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1A shows a prospective view of an example expandable and connectable planting pot module in accordance with this application.

FIG. 1B shows an enlarged view of lip of an example expandable and connectable planting pot module in accordance with this application.

FIG. 2A shows a plan view of bottom plate of an example expandable and connectable planting pot module in accordance with this application.

FIG. 2B shows a bottom view of alternative handle of bottom portion of an example expandable and connectable planting pot module in accordance with this application.

FIG. 3A shows a plan view of a grinder bottom plate of an example expandable and connectable planting pot module in accordance with this application.

FIG. 3B shows a cross-sectional view of bottom portion of FIG. 3A at the middle line.

FIG. 3C shows an enlarged view of a protrusion on the upper surface of bottom portion of an example expandable and connectable planting pot module in accordance with this application.

FIG. 4A shows a bottom view of an example locking mechanism for the bottom plate of an example expandable and connectable planting pot module in accordance with this application.

FIG. 4B shows a bottom view of an alternative example locking mechanism for the bottom plate of an example expandable and connectable planting pot module in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the design apply to any suitable material for making a product, the shape of the body may be cylindrical or multi-edged or reversed-frustoconical for easy stacking. For clarity reason, the examples are given in cylindrical shape, but an ordinary person in the art would know the variations to modify the design to make other shapes.

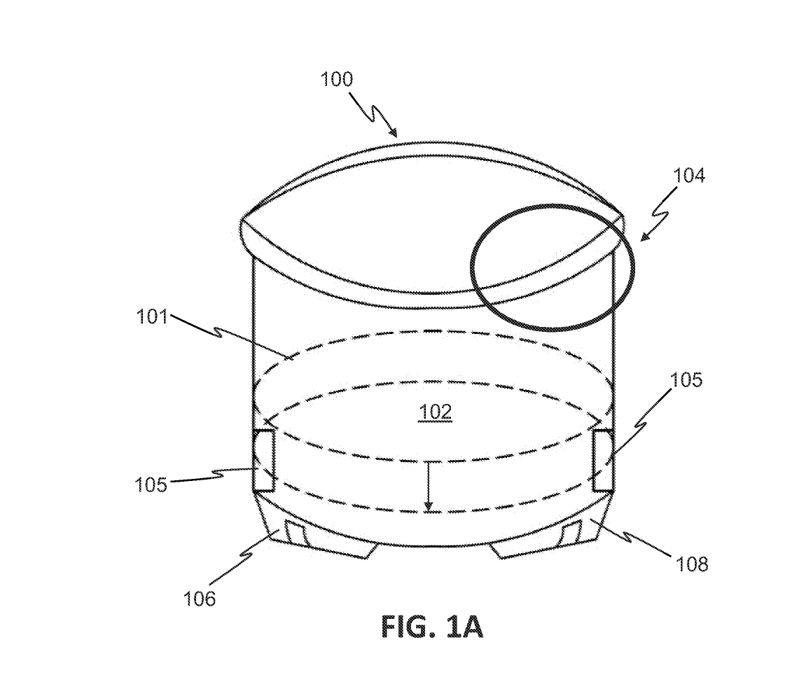

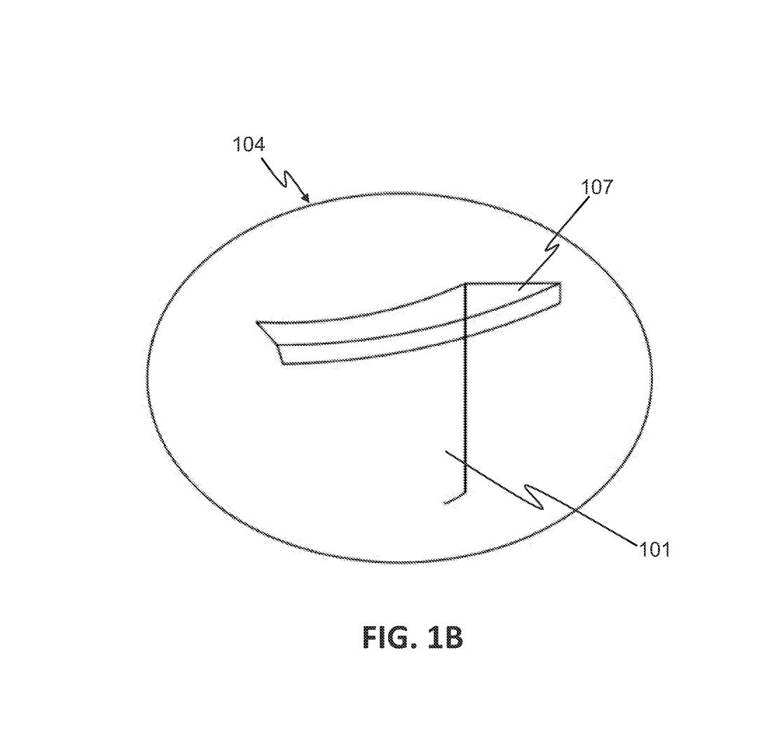

In reference to FIG. 1A, a connectable planting pot module 100 includes a housing portion 101 formed by lateral wall with interior and exterior surface, and a bottom portion 102 which is movably and detachably connected to lower end of housing portion 101, forming a housing space to accommodate growing medium. A plurality of apertures 106 are spread along the edge or feet 108 of the bottom of pot module 100 allowing water drainage and aeration. It can be either solid or hollow between the interior and exterior surfaces of the lateral wall. If the lateral wall is hollow, to add stability, regularly arranged ribs can be built between the surfaces of lateral wall.

In one embodiment of present invention as shown in FIG. 1A, housing portion 101 may have a smaller or same diameter in its lower end than its upper end, forming a cylindrical recess 105 at lower end of lateral wall. When it is time to transplant the plants or crops, the bottom portion of the first pot module is to be removed. Such recess 105 may make the first pot module to be easily and securely sleeved into the second pot module along the vertical axis of said housing portion 101. As such additional growing space for the root system can be provided.

Yet in another embodiment of present invention as shown in FIG. 1B, lip of the pot module 107 comes out all the way around in continuant thickness, preferably with ¼″ of the outer edge curling down at 90 degree angle.

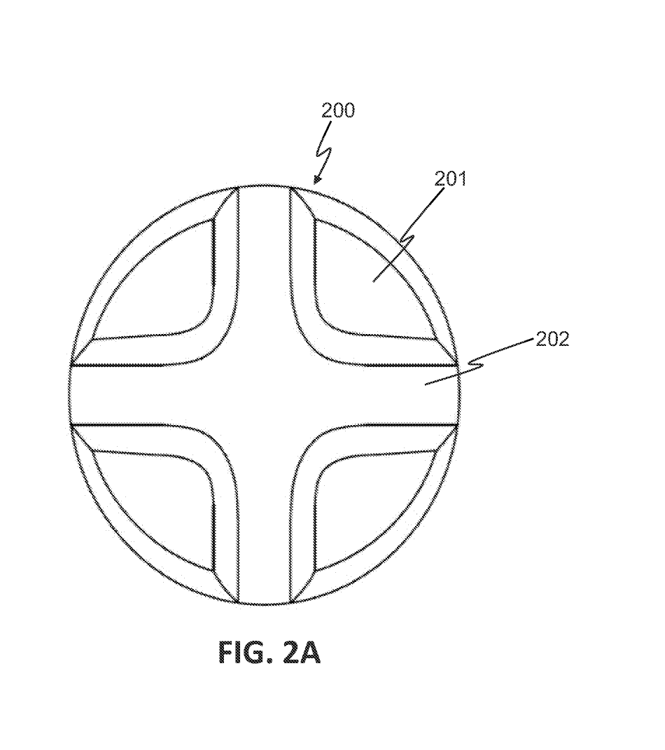

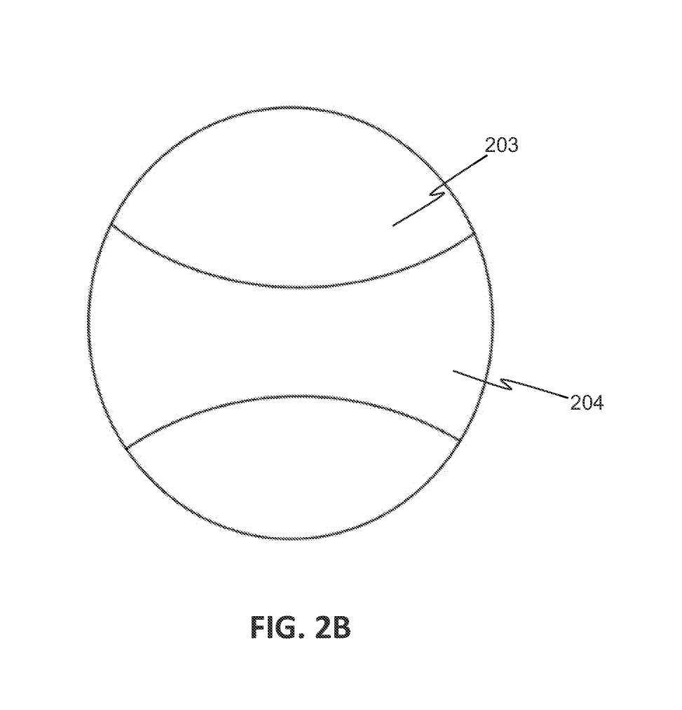

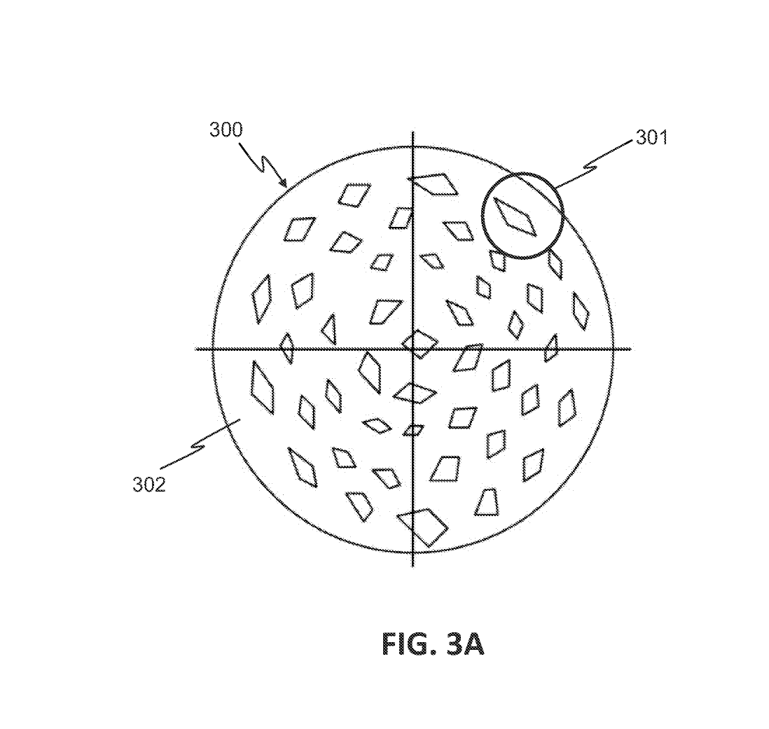

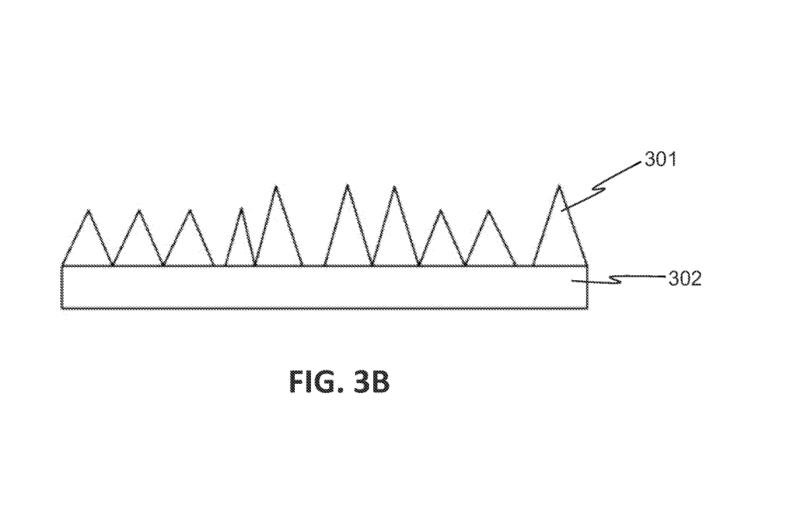

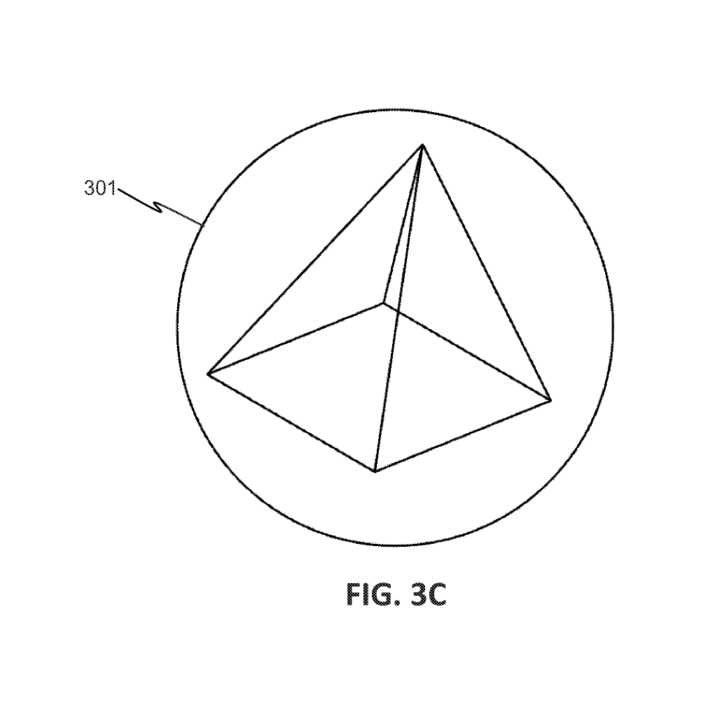

FIG. 2A shows a bottom view of one exemplar detachable bottom portion 102 of the present invention. The present exemplar bottom portion 102 comprises an exterior surface 201, and an optional interior surface 300 as shown in FIG. 3A so that bottom plate 200 can be used as a grinding tool for the hardened plant root during expansion.

A handle 202 is fixed to the exterior surface 201 to provide a griping place for human hand to apply force. Alternatively, the handle is shaped as handle 204 in FIG. 2B. Handle 202 or 204 rises outwardly from the lower surface of bottom portion 102, naturally forming multiple recess areas 201 or 203. No matter in what shape, handle 202 is an integral part of the bottom portion and is in substantially stable contact with the supporting surface.

In reference to FIG. 3A, the interior surface 300 bears a plurality of protrusions 301 on the base plate surface 302. FIG. 3C shows an isometric view of one of the many protrusions. Such protrusions 301 project outwardly from the base surface 302 of detachable bottom portion 102. They may be made in shapes of cone or square pyramidal. In one embodiment of the present invention, the heights of such protrusions are about 1 inch.

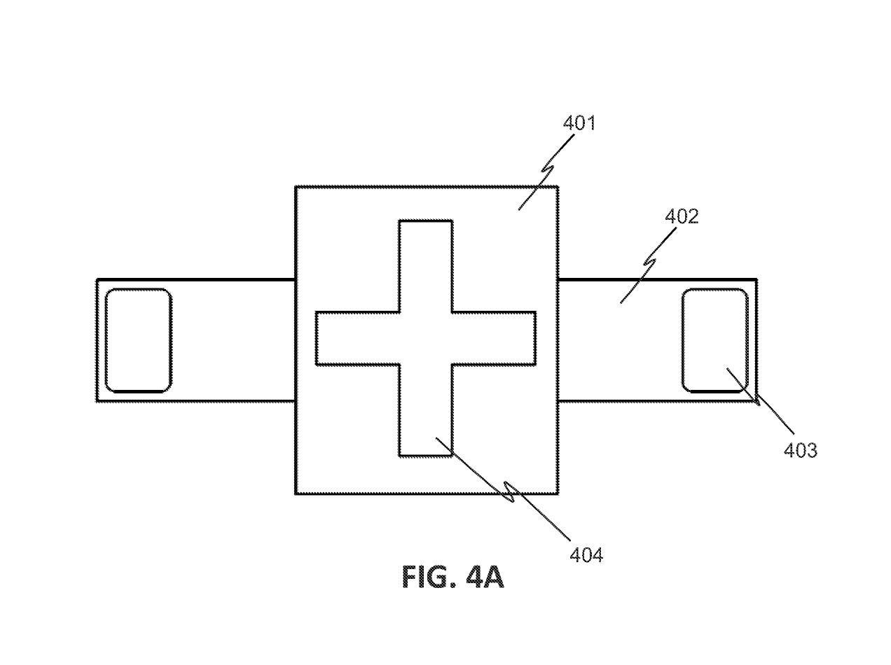

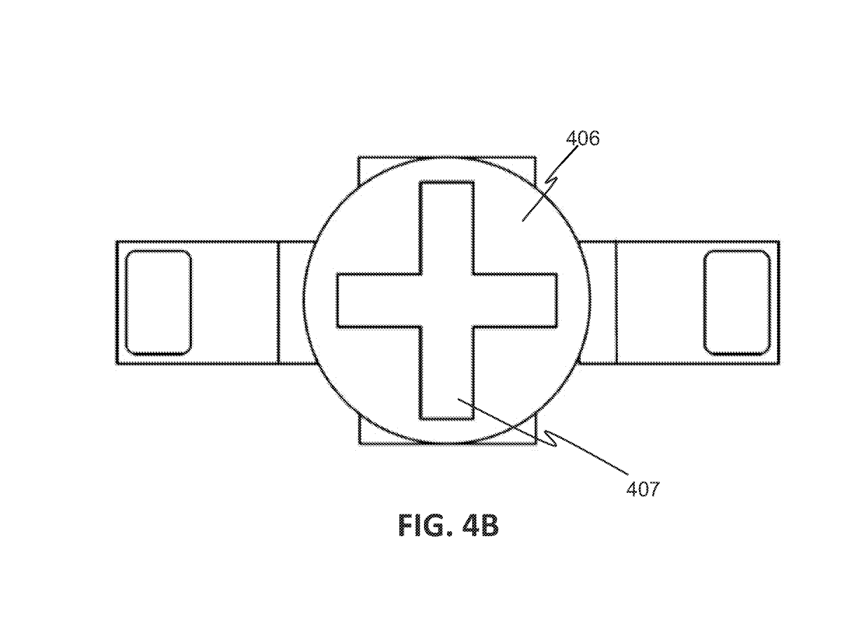

FIG. 3B shows a cross-sectional view of an exemplar bottom portion of FIG. 3A, taken along the middle line. As shown in FIG. 3B, the bottom portion 102 has a thickness to form a cylindrical out wall. The bottom portion 102 is securely locked to the bottom of the pot through a locking mechanism shown in FIGS. 4A and 4B. When extra growing space is desired for the root, the bottom portion 102 can be unlocked and twist off from the housing portion 101. A human hand may grab the handle 202 or 204 of bottom portion 102.

FIGS. 4A and 4B show a locking mechanism design for the bottom plate 102.

In reference to FIG. 4A, locking grip tape includes a plate portion 401, a belt portion 402 with apertures 403 on each end, and a handle 404 is configured to accommodate human hand, all of which are connected together to form a fastening mechanism. The belt 402 is bendable to fit into the bottom of the pot, so that the apertures 403 can interact with the interior surface of wall 101, and being fastened to a lightly protrusions (not shown) on the interior wall 101. Plate portion 401 therefore provides support for bottom plate 102. Plate 401 is of substantially the same diameter as lower end of housing portion 101. When twisting the handle 404, it will lock into the lower end of housing portion 101 and tighten against the belt 402 and plate 401 until the whole bottom portion securely attached to the housing portion 101. FIG. 4B shows an alternative shape of plate 406. The shape of plate 401 match the shape of base plane of housing portion 101.

The length of belt 402 may be configured to be adjustable or extendable. Belt 402 may be made of plastics or metal or other suitable material.

When additional growing space is needed for the root system, the locking mechanism is twisted off and the plate 102 will be detached from the lower end of housing portion 101 and be moved to a lower position to expand. Alternatively another pot can be stacked to the lower end of housing portion 101 of the first pot module from which the bottom plate has been removed to form a new pot. The housing portion of two pot module will align vertically and thereby addition growing space can be provided.

Bottom plate 102 as shown in FIGS. 3A and 3B may be configured to have plurality of protrusions to be used as grinding tool to grind up the bottom soil of a plant.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in the following patents, all of which are hereby incorporated by reference herein for all purposes: U.S. Pat. No. 5,930,951 A, and U.S. Pat. No. 7,673,416 B2.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A expandable planting pot module having a plurality of apertures allowing water drainage and aeration, comprising:
a housing portion formed by a lateral wall, having a interior and a exterior surface, said housing portion having the same diameter in its lower end than its upper end, forming a recess at lower end of said lateral wall, thereby enabling said lower end of housing portion to be securely slide into the upper end of said housing portion of added planting pot module along the vertical axis of both housing portions, and
a bottom plate, detachably mounted to said housing portion, forming a housing space to accommodate growing medium.

2. The expandable planting pot module of claim 1, wherein said plate comprising:
an upper surface facing said housing portion, and
a lower surface disposed to accommodate a human hand to apply force to remove said bottom plate from said housing portion.

3. The expandable planting pot module of claim 1, wherein said detachable bottom plate is secured by a locking mechanism.

4. The expandable planting pot module of claim 2, wherein said bottom plate further comprising:
a plurality of spike like protrusions pointing upwardly into said housing portion, so as to generate grinding effect on the hardened root ball when being removed off from said housing portion.

5. The expandable planting pot module of claim 4, wherein said plurality of spike like protrusions are in the shape of a cone.

6. The expandable planting pot module of claim 4, wherein said plurality of spike like protrusions are in the shape of a square pyramidal.

7. The expandable planting pot module of claim 3, wherein said locking mechanism comprises a plate with substantially the same shape as said base plate, an extendable belt with apertures to be engaged into a locking protrusion, and a handle being placed against said belt and said plate, wherein said handle, said belt and said plate are disposed together to perform the fastening function.

8. The connectable planting pot module of claim 7, wherein said belt is made of bendable and durable material.
